(19) United States
(12) Patent Application Publication
(10) Pub. No.: US 2007/0200437 A1
(43) Pub. Date: Aug. 30, 2007

(54) Stator assembly and manufacturing method

(76) Inventors: Ahmed M. El-Antably, Indianapolis, IN (US); Timothy J. Alfermann, Fishers, IN (US); Arthur L. McGrew JR., Plainfield, IN (US); Charles B. Lucas, Indianapolis, IN (US); Molly A. Waechter, Greensburg, IN (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 11/363,557

(22) Filed: Feb. 27, 2006

(51) Int. Cl. H02K 15/12; H02K 1/00; H02K 1/12

(52) U.S. Cl. 310/45; 310/259; 310/216

(57) ABSTRACT

The apparatus of the present invention provides a stator assembly for an electric device such as a motor or a generator. The stator assembly preferably includes a generally annular stator core having a plurality of stator teeth. A stator wire is wound around each of the stator teeth to form a stator coil. An epoxy resin is applied to the stator coil and around each of the stator teeth such that the stator wire is coated and thereby electrically isolated by the epoxy resin. A coolant channel at least partially defined by the epoxy resin is positioned in close proximity to the stator coil such that the stator assembly remains cool. A corresponding method for manufacturing such a stator assembly is also provided.

### GOVERNMENT LICENSE RIGHTS

The U.S. Government has a paid-up license in this invention and the right in limited circumstances to require the patent owner to license others on reasonable terms as provided for by the terms of ZCL-3-32060-02 awarded by NREL/DOE.

### TECHNICAL FIELD

The present invention pertains generally to a stator assembly and manufacturing method therefore.

### BACKGROUND OF THE INVENTION

Electric devices such as motors and generators having a stator secured within the housing of the motor or generator are well known. A rotor mounted on a shaft is positioned within the stator and is rotatable relative to the stator about the longitudinal axis of the shaft. Transmission of current through the stator creates a magnetic field tending to rotate the rotor and the shaft mounted thereto. It is also well known that it is necessary to maintain the stator within a predefined temperature range and to keep the stator free of contaminants in order to ensure optimal performance of the electric device.

### SUMMARY OF THE INVENTION

The stator assembly of the present invention includes a generally annular stator core having a plurality of stator teeth. A stator wire is wound around each of the stator teeth to form a stator coil. An epoxy resin is applied to the stator coil and around each of the stator teeth such that the stator wire is coated and thereby electrically isolated by the epoxy resin. A coolant channel at least partially defined by the epoxy resin is positioned in close proximity to the stator coil such that the stator assembly remains cool.

A preferred method for manufacturing the stator assembly of the present invention is initiated by assembling a plurality of stator tooth components to form the stator tooth. Thereafter, stator wire is wrapped around the stator tooth to form the stator coil thereby defining a pole. Epoxy resin is applied to the stator coil such that the stator wire is coated and electrically isolated. A plurality of poles are assembled together to form a generally annular stator assembly. A second layer of epoxy resin is preferably applied to the plurality of poles to maintain their attachment to each other.

According to one aspect of the invention, the epoxy resin is configured to facilitate the transfer of heat from the stator coil through the coolant channel and out of the stator assembly.

According to another aspect of the invention, the epoxy resin is configured to prevent the introduction of contaminants into said stator coil.

According to yet another aspect of the invention, the epoxy resin is configured to increase the strength of the stator core.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional diagram of an electric motor including a stator assembly in accordance with the present invention;

FIG. 2 is a sectional view of the stator assembly of FIG. 1;

FIG. 3a is a perspective view of the stator assembly of FIG. 1; and

FIG. 3b is a perspective view of a component of the stator assembly of FIG. 3a.

### DESCRIPTION OF THE PREFERRED EMBODIMENTS

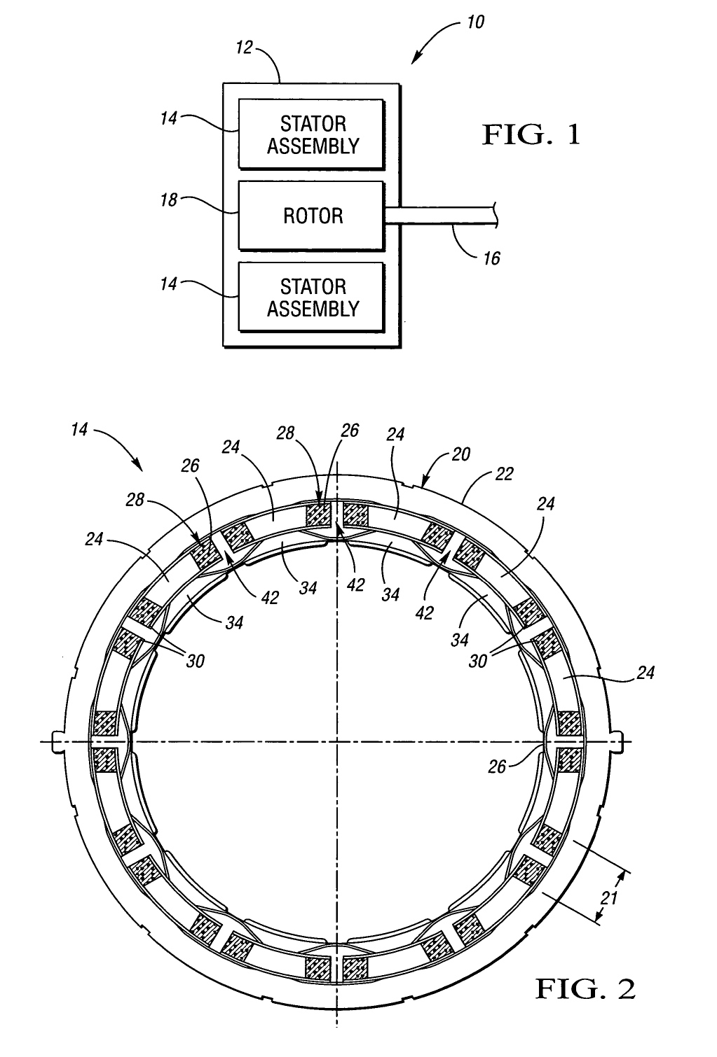

Referring to the drawings wherein like characters represent the same or corresponding parts through the several views, there is shown in FIG. 1 a schematic representation of an electric motor 10. The electric motor 10 is shown for illustrative purposes in accordance with the preferred embodiment; however it should be appreciated the present invention is adapted for use with other electric motor configurations and other electrical devices such as, for example, a generator. The electric motor 10 includes a housing 12, a stator assembly 14, a shaft 16, and a rotor 18. The stator assembly 14 is substantially annular and is configured to remain stationary relative to the housing 12 during operation of the motor 10. The rotor 18 is mounted to the shaft 16 and is generally circumscribed by the stator 14. The rotor 18 and shaft 16 are rotatable relative to the housing 12 and the stator 14.

Referring to FIG. 2, the stator assembly 14 preferably includes a stator core 20 having a stator shell 22, a plurality of stator teeth 24 extending therefrom which form slots 21 therebetween, and a stator wire 26 wound or wrapped around each of the stator teeth 24 to at least partially fill the slots 21 and form a stator coil 28. The stator coil 28 is impregnated with epoxy resin 30 such that the stator wire 26 is coated with epoxy resin 30 and the windings of the stator coil 28 are electrically isolated from each other. An epoxy resin type 66-2251 commercially available from Wabash Magnetics LLC., located at 1450 First Street, Wabash, Ind. 46992, is preferably implemented for the epoxy resin 30. According to a preferred embodiment, the stator core 20 is composed of a soft magnetic composite or SMC to reduce cost and simplify manufacturing, and the stator wire 26 is composed of copper. According to an alternate embodiment, the stator core 20 may be composed of steel laminations. It should be appreciated; however, that alternate epoxy resin, stator core and/or stator wire compositions may be envisioned.

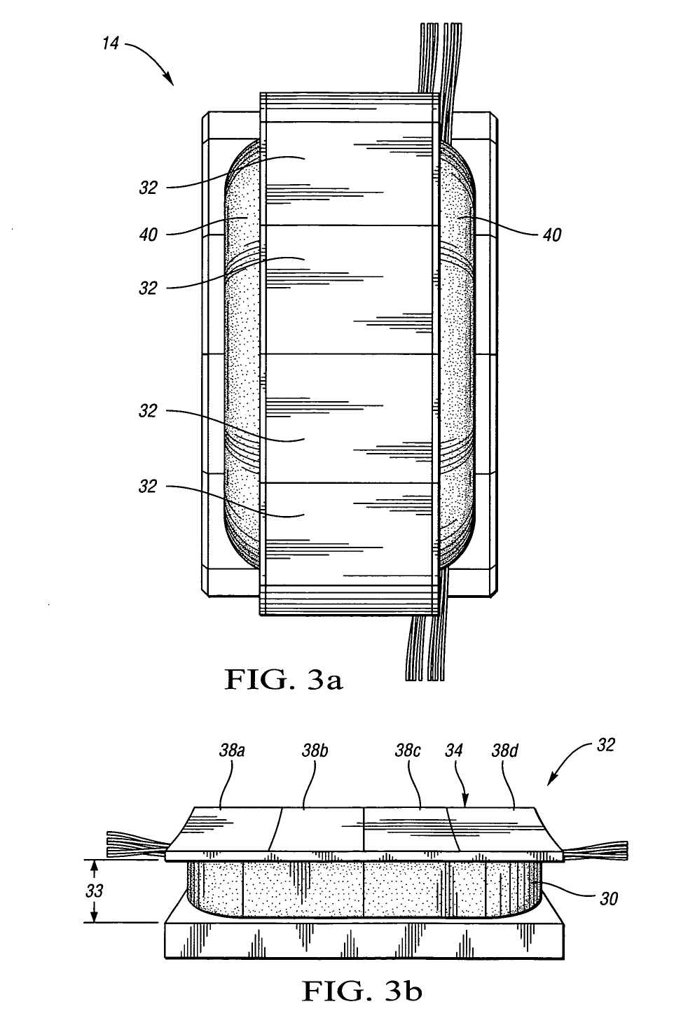

Still referring to FIG. 2, each stator tooth 24 and the stator wire 26 wrapped therearound will hereinafter be referred to as a “pole” 32. Each pole 32 is preferably wound separately to maximize the number of windings within a given volume and thereby optimize the electric motor 10 (shown in FIG. 1) performance. The stator teeth 24 each extend radially inward from the shell 22 and terminate in a flanged end portion 34. The stator teeth 24 form a slot 33 (shown in FIG. 3b) defined between the shell 22 and the end portion 34. The epoxy resin 30 is disposed about the periphery of each stator tooth 24 between the shell 22 and the respective flanged end portion 34, such that at least a portion of each pole 32 including the stator wire 26 is encapsulated by the resin 30. The addition of the epoxy resin 30 in the manner described hereinabove increases the strength of the stator assembly 14 and also provides additional damping. This increase in strength of the stator assembly 14 is particularly advantageous for the preferred embodiment wherein the stator core 20 is composed of a soft magnetic composite. The damping characteristics of the epoxy resin 30 allows for the absorption of vibrations generated by the electric motor 10 that may otherwise be objectionable thereby providing smoother operation.

Referring to FIG. 3a, a perspective view of the stator assembly 14 in accordance with the preferred embodiment is shown. The stator assembly 14 is composed of twelve pre-assembled poles 32 that are connected together. As shown in FIG. 3b, the poles 32 preferably each include four components 38a, 38b, 38c and 38d. The four components 38a, 38b, 38c and 38d are assembled together to form a single tooth 24 (shown in FIG. 2), stator wire 26 (shown in FIG. 2) is then wrapped around the tooth 24 to form a stator coil 28 (shown in FIG. 2), and epoxy resin 30 is applied in the manner described hereinabove to encapsulate the stator coil 28 and retain the components 38a, 38b, 38c and 38d. Referring to FIGS. 3a-3b, the stator coils 28 (shown in FIG. 2) for each of the twelve poles 32 are electrically interconnected by the stator wire 26 (shown in FIG. 2) such that current is transferable between the poles 32. According to the preferred embodiment, the twelve pre-assembled poles 32 are fixtured with a conventional fixturing device (not shown) and a second layer of epoxy resin 40 is applied over the epoxy resin 30 between the stator shell 22 (shown in FIG. 2) and the flanged end portion 34 of each tooth 24 to retain the twelve poles 32 that form the stator assembly 14.

Referring again to FIG. 2, a plurality of coolant holes or channels 42 are defined by the epoxy resin 30 and/or the epoxy resin 40, and are preferably located in close proximity to the stator coils 28. Cooling fluid (not shown) is transferred through the coolant channels 42 to absorb heat and thereby cool the electric motor 10 (shown in FIG. 1). Advantageously, the coolant channels 42 of the present invention are positioned to be closer to the stator coils 28 than cooling channels formed in a housing. As the stator coils 28 are a primary source of heat, the proximity of the coolant channels 42 thereto more efficiently cools the electric motor 10. According to a preferred embodiment, the coolant channels 42 are gaps between the epoxy covered stator coils 28 of each of the twelve poles 32 such that the channels 34 are at least partially defined by the epoxy resin 30 and/or the optional second layer of epoxy resin 40. The coolant channels 34 may be formed with inserts applied during the solidification of the epoxy resin 30 and/or the epoxy resin 40, or may be formed in any other known manner such as with conventional machining processes.

The epoxy resin 30 has good thermal conduction properties and therefore enhances the thermal conductivity between the stator coils 28 and the cooling fluid (not shown). Accordingly, the thermal conduction of the epoxy resin 30 facilitates the process of transferring heat from the stator coils 28 out of the stator assembly 14 to cool the electric motor 10 (shown in FIG. 1). The epoxy resin 30 also acts as an electrical isolator to prevent each of the individual windings of the stator coils 28 from forming an electrical connection therebetween and/or with the stator core 20 and thereby short circuiting the electric motor 10. It was conventionally necessary to coat the stator wire with varnish to avoid a short circuit; however this step is no longer required as the process of impregnating the stator coils 28 with epoxy resin 30 coats the stator wire 26 to electrically isolate each individual winding.

It has typically been necessary to exercise caution to prevent contamination of the stator coils during shipping and assembly into an electric motor. This was necessary because debris within the stator coil or introduced by gears (not shown) may degrade performance and durability of the electric motor 10. The stator poles 32 are preferably assembled and thereafter the stator coil 28 is encapsulated with epoxy resin 30 in the manner described hereinabove to form the stator assembly 14. Therefore, the completed stator assembly 14 can be shipped and installed without fear of contamination such that the electric motor 10 (shown in FIG. 1) is more durable than conventional electric motors.

A method for manufacturing the stator assembly of this invention is described as follows. Each pole 32 (shown in FIG. 3b) is concentrically wound to achieve the highest possible slot fill which is very important for achieving high performance. Each pole 32 is then encapsulated by a material such at the epoxy resin 30 which has high thermal conductivity, high isolating characteristics, and provides adequate mechanical strength. Several poles 32 are assembled in a fixture (not shown) to form the stator assembly 14. Further isolation may be provided by encapsulating the stator assembly 14 with epoxy resin 30 to form one solid structure. In production, this process is automated so that the poles 32 are assembled before encapsulation, and thereafter encapsulation is automatically applied in one step to provide very fast cycle production. Holes or channels 42 are incorporated in the encapsulation to provide very effective cooling and thus very high power density machines, which is desirable for hybrid applications due to severe constraints on packaging. Cooling oil (not shown) may then be passed very close to the source of heat, which allows very efficient cooling. This invention can be applicable to steel as well as SMC parts. For SMC parts, it is particularly important as it provides mechanical integrity to the stator structure which may otherwise be vulnerable to breakage in heavy duty stator applications. In sum, the invention herein described provides for an efficient and closed liquid cooling system which provides a dry machine with reduced drag losses and protection for the windings.

While the best modes for carrying out the invention have been described in detail, those familiar with the art to which this invention relates will recognize various alternative designs and embodiments for practicing the invention within the scope of the appended claims.

1. A stator assembly for an electronic device comprising:
a generally annular stator core including a plurality of stator teeth;
a stator wire wound around each of said plurality of stator teeth to form a stator coil; and
an epoxy resin applied to said stator coil and around each of said plurality of stator teeth such that said stator wire is coated and thereby electrically isolated by the epoxy resin.

2. The stator assembly of claim 1, further comprising a coolant channel positioned in close proximity to at least a portion of said stator coil.

3. The stator assembly of claim 1, wherein said plurality of stator teeth each include a flanged end portion adapted to retain said stator wire and said epoxy resin as it solidifies.

4. The stator assembly of claim 1, wherein said stator core is composed of a soft magnetic composite.

5. The stator assembly of claim 1, wherein said epoxy resin is configured to facilitate the transfer of heat from the stator coil through the coolant channel and out of the stator assembly.

6. The stator assembly of claim 1, wherein said epoxy resin is configured to prevent the introduction of contaminants into said stator coil.

7. The stator assembly of claim 1, wherein said epoxy resin is configured to increase the strength of the stator core.

8. A stator assembly for an electronic device comprising:
a generally annular stator core including a plurality of stator teeth;
a stator wire wound around each of said plurality of stator teeth to form a stator coil;
an epoxy resin applied to said stator coil and around each of said plurality of stator teeth such that said stator wire is coated and thereby electrically isolated by the epoxy resin; and
a coolant channel at least partially defined by said epoxy resin, said coolant channel positioned in close proximity to at least a portion of said stator coil.

9. The stator assembly of claim 8, wherein said plurality of stator teeth each include a flanged end portion adapted to retain said stator wire and said epoxy resin as it solidifies.

10. The stator assembly of claim 8, wherein said stator core is composed of a soft magnetic composite.

11. The stator assembly of claim 8, wherein said epoxy resin is configured to facilitate the transfer of heat from the stator coil through the coolant channel and out of the stator assembly.

12. The stator assembly of claim 8, wherein said epoxy resin is configured to prevent the introduction of contaminants into said stator coil.

13. The stator assembly of claim 8, wherein said epoxy resin is configured to increase the strength of the stator core.

14. A method for manufacturing a stator assembly comprising:
providing a stator tooth;
wrapping stator wire around said stator tooth to form a stator coil, said stator coil disposed about said stator tooth defining a pole;
applying epoxy resin to said stator coil such that said stator wire is coated and electrically isolated by the epoxy resin; and
assembling a plurality of poles to form a generally annular stator assembly.

15. The method of claim 14, wherein said providing a stator tooth includes assembling a plurality of stator tooth components to form said stator tooth.

16. The method of claim 14, further comprising forming a coolant channel at least partially defined by said epoxy resin.

17. The method of claim 16, further comprising applying a second layer of epoxy resin to said plurality of poles to maintain the attachment thereof.
